(19) United States
(12) Patent Application Publication
(10) Pub. No.: US 2019/0007253 A1
(43) Pub. Date: Jan. 3, 2019

(54) MULTI-CHANNEL TIME SYNCHRONIZED WIRELESS NETWORKING WITH RESOURCE AGGREGATION

(71) Applicant: Intel IP Corporation, Santa Clara, CA (US)

(72) Inventors: Dave Cavalcanti, Portland, OR (US); Chittabrata Ghosh, Fremont, CA (US); Ou Yang, Santa Clara, CA (US)

(73) Assignee: Intel IP Corporation, Santa Clara, CA (US)

(21) Appl. No.: 15/636,880

(22) Filed: Jun. 29, 2017

(51) Int. Cl. H04L 27/26; H04W 48/08; H04W 72/04

(52) U.S. Cl. CPC H04L 27/2662; H04W 28/06; H04W 72/0446; H04W 48/08

(57) ABSTRACT

A wireless communication device, method and product. The device includes a memory and processing circuitry coupled to the memory. The processing circuitry comprises logic and is configured to: process a time synchronization function (TSF) information element (IE) from an access point (AP), the TSF IE including information on a plurality of transmit opportunity (TXOP) slots in a frequency domain and in a time domain, the TXOP slots indicating respective narrowband channels of a wideband channel in the frequency domain for communication with the device; generate a data frame based on the TSF IE; and cause transmission of the data frame over a subset of the TXOP slots, the subset being aggregated over at least one of the frequency domain and the time domain.

### TECHNICAL FIELD

This disclosure generally relates to systems, methods, and devices for wireless communications and, more particularly, to multi-channel time synchronized mesh networking in wireless networks, such as in Wi-Fi Wireless Local Area Networks (WLAN) under the Institute of Electrical and Electronics Engineers (IEEE) 802.11 standard and related amendments.

### BACKGROUND

A need for efficient use of resources within a wireless network requires continuous improvement of the use of time and frequency resources within that network. Low-power wireless devices such as Internet-of-Things (IoT) devices are becoming more and more prevalent, and are now among the many devices requesting access to wireless resources, such as those within a WLAN. IoT devices may have differing needs with respect to resource use as compared with their non-IoT counterparts, and may need more robust resource scheduling mechanisms to allow them to save power.

### BRIEF DESCRIPTION OF THE DRAWINGS

FIG. 1 depicts a diagram illustrating an example network environment for an illustrative narrowband mesh networking system, according to some demonstrative embodiments;

FIG. 2 depicts a narrowband channel allocation, according to some demonstrative embodiments;

FIG. 3 depicts a radio system configured according to some demonstrative embodiments;

FIG. 4a depicts a narrowband service channel timeslot/time synchronization function (TSF) schedule;

FIG. 4b depicts a narrowband service channel timeslot/time synchronization function (TSF) schedule according to some demonstrative embodiments;

FIG. 5 depicts a narrowband service channel TSF Information Element (IE) structure in the time domain, according to some demonstrative embodiments;

FIG. 6a illustrates a flow-chart of a first method according to some demonstrative embodiments;

FIG. 6b illustrates a flow-chart of a second method according to some demonstrative embodiments; and

FIG. 7 illustrates a product of manufacture in accordance with some demonstrative embodiments.

### DETAILED DESCRIPTION

Next generation 3GPP 5G and Wi-Fi networks are expected to focus on better user experiences under high density scenarios, as well as enabling connectivity for a large number of IoT devices, which are typically resource and power constrained. Many large scale IOT systems, such as smart grids/buildings/cities, and industrial automation as a few examples, require flexible and scalable mesh network architectures. In many cases, devices may be outside the coverage of an access point (AP) due to power restrictions, extended area/sparse deployment or other constraints. It is desirable to enable a more efficient support for mesh networking and resource constrained/low power devices within next generation/5G Wi-Fi networks.

According to some demonstrative embodiments, wireless communication devices enable aggregation of multiple Transmit Opportunity (TXOP) slots or cells in the frequency domain and time domain within a narrowband network, such as a narrowband Wi-Fi network. Default TXOP slots sizes in frequency and time may be configured to enable small data packets for power constrained STAs, while higher priority and larger packets may be transmitted across TXOP slots in an aggregated manner in frequency and/or time.

Advantageously, embodiments provide a flexible and scalable channel access mechanism and better support for multiple types of traffic and device requirements in a wireless network, and especially in a narrowband wireless network involving IoT devices. Existing IoT networks, such as those defined in IEEE 802.15.4e, have very limited capacity to enable convergence/coexistence of heterogenous applications, such as sensor data reporting and video surveillance, in the same network. IEEE 802.15.4e defines a Time Synchronized Channel Hopping (TSCH) protocol that enables multi-channel time synchronized transmissions, where STA transmissions are restricted to a single TXOP slot or cell, the slot having a fixed size in time and frequency. Additionally, in an 802.15.4e system, the STA cannot transmit across multiple TSCH slots, given that 802.15.4e does not have capability to aggregate multiple narrowband channels.

Example embodiments relate to devices, systems and methods for enabling support for mesh networking and resource constrained and low power devices within next generation/5G Wi-Fi networks. The descriptions herein are for purposes of illustration and are not meant to be limiting. Numerous other examples, configurations, processes, etc., may exist, some of which are described in detail below. Example embodiments will now be described in more detail with reference to the accompanying figures.

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

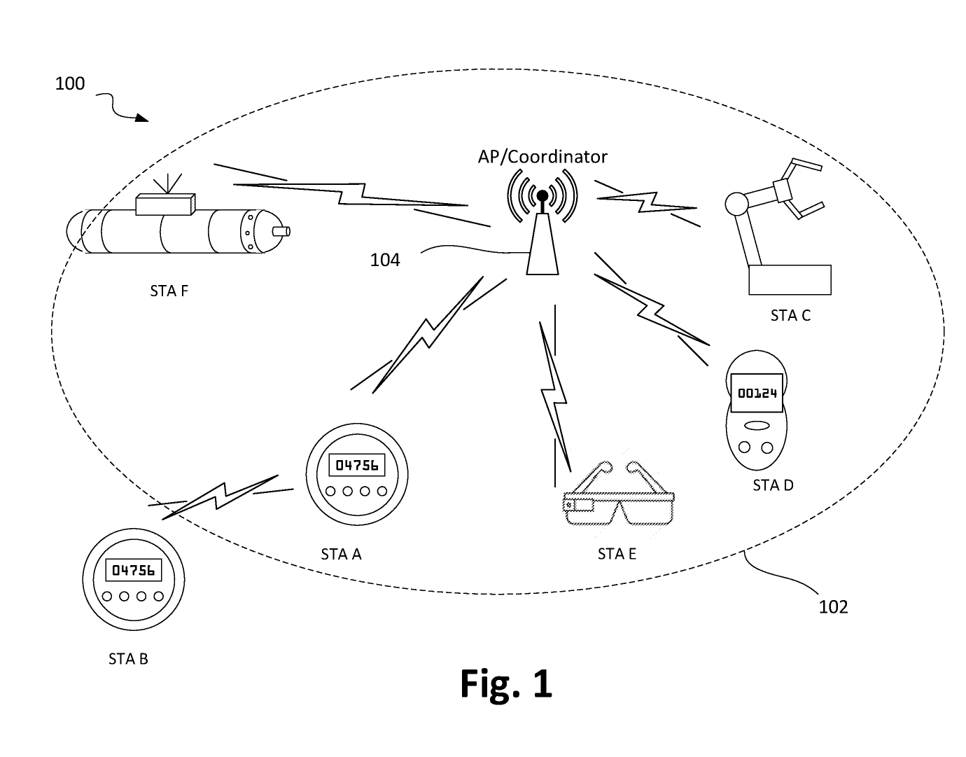

FIG. 1 is a diagram illustrating an example network environment, according to some demonstrative embodiments. Wireless network 100 may include one or more wireless stations (STAs) STA A, STA B, STA C, STA D, STA E and one or more access point(s) AP, such as AP 104, which may communicate in accordance with various communication standards and protocols, such as, Wi-Fi, IEEE 802.15.4 low-rate Wireless Personal Area Networks (WPAN), Wireless Universal Serial Bus, Wi-Fi Peer-to-Peer (P2P), Bluetooth, Near Field Communication, or any other communication standard. The STAs may include mobile devices that are non-stationary (e.g., not having fixed locations) or may they may be stationary devices. The STAs as shown in FIG. 1 may include IoT devices, such as sensors, actuators, gauges and mobile devices as a few examples.

As used herein, the term “Internet of Things (IoT) device” is used to refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT devices may include, but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communications interface for communicating with the IoT network. IoT devices may also include slot phones, desktop computers, laptop computers, tablet computers, personal digital assistants (PDAs), etc. Accordingly, the IoT network may be comprised of a combination of “legacy” Internet-accessible devices (e.g., laptop or desktop computers, slot phones, etc.) in addition to devices that do not typically have Internet-connectivity (e.g., dishwashers, etc.).

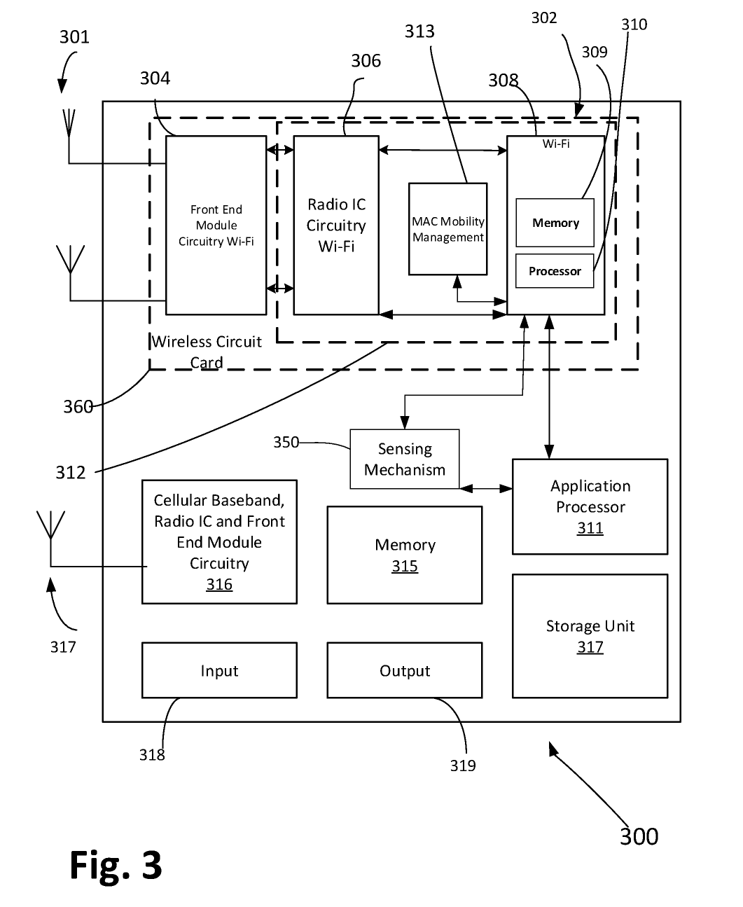

In some embodiments, the STAs and AP 104 of FIG. 1 may include one or more systems similar to that of the radio system shown by way of example in FIG. 3 to be described further below. The STA and/or AP of FIG. 1 may also include mesh stations in, for example, a mesh network, in accordance with one or more IEEE 802.11 standards and/or 3GPP standard, or higher layer standards (such as, for example, a network layer standard) managed by the Internet Engineering Task Force (IETF) community, such as, for example, the Routing Protocol for Low power and Lossy Networks (RPL) routing standard. Any of the STAs and AP of FIG. 1 may be configured to communicate with each other via one or more communications networks. The STAs of FIG. 1 may also communicate directly with each other without the intermediary of AP 104 (in a P2P fashion).

Any of the STAs or AP of FIG. 1 may be configured to perform directional transmission and/or directional reception in conjunction with wirelessly communicating in a wireless network. Any of the STAs or AP of FIG. 1 may be configured to perform such directional transmission and/or reception using a set of multiple antenna arrays (e.g., DMG antenna arrays or the like). Each of the multiple antenna arrays may be used for transmission and/or reception in a particular respective direction or range of directions. Any of the STAs or AP of FIG. 1 may be configured to perform any given directional transmission towards one or more defined transmit sectors. Any of the STAs or AP of FIG. 1 may be configured to perform any given directional reception from one or more defined receive sectors. MIMO beamforming in a wireless network may be accomplished using RF beamforming and/or digital beamforming. In some embodiments, in performing a given MIMO transmission, the STAs or AP of FIG. 1 may be configured to use all or a subset of its one or more communications antennas to perform MIMO beamforming.

Referring still to FIG. 1, AP 104 and STA A, STA C, STA D, STA E and STA F together form a basic service set (BSS) 102 that is defined by a wireless coverage area of the AP. STA B is shown as being outside the coverage area of AP 104, but as able to connect to BSS 102 and to AP 104 for communication therebetween by way of STA A, with STA A acting as a relay node/router for STA B. When a STA, such as STA B, is outside the coverage area of the BSS, according to some embodiments, it may still be able to communicate with AP 104, although at a lower rate and/or with a lower performance as compared with a scenario where the STA would be within the AP's BSS. For example, if power measurements or link quality for the link between STA B and should fall below a threshold, STA B may switch to STA A and use STA A as a relay/router to gain access to AP 104 should STA A be available. The fact of STA A acting as a relay to a STA outside of BSS 102 means that network 100 may be characterized as a mesh network using a multi-hop mechanism (in this case from STAB to STA A to AP 104). The multi-hop mesh network may operate in a time-synchronized fashion, and further in a way to allow resources aggregation in the frequency and time domains according to some demonstrative embodiments, as will be explained in further detail below.

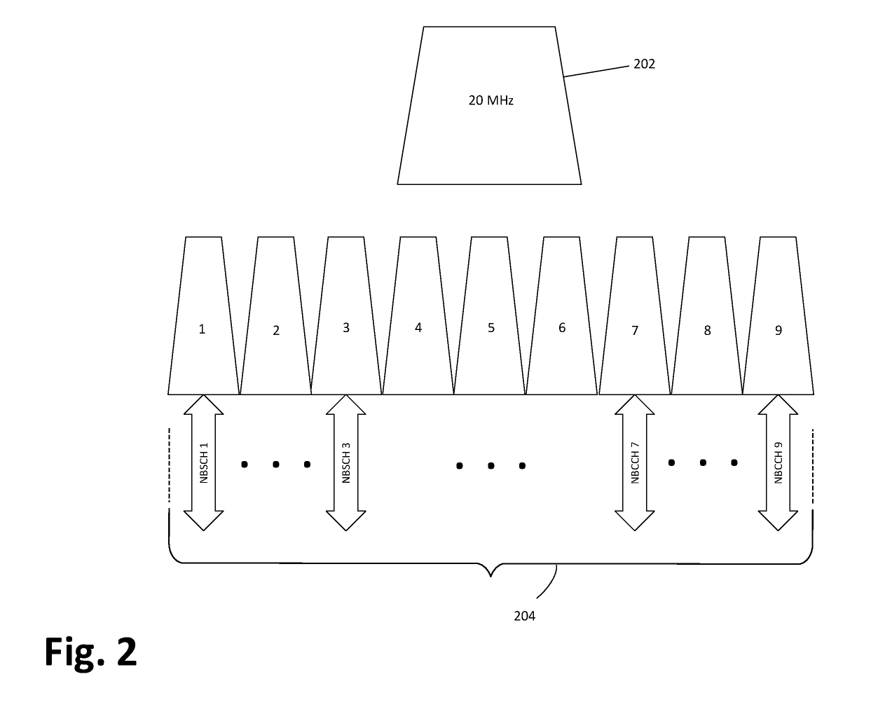

The STAs and AP of the multi-hop mesh network 100 may be configured to communicate using narrowband (NB) subchannels of a wideband channel according to some demonstrative embodiments, as will be explained in further detail in relation to FIG. 2 below. For example, according to one embodiment, a STA and/or AP according to demonstrative embodiments may be configured to use a narrowband channel of a wideband 20 MHz channel in order to communicate in a synchronized fashion with devices within the multi-hop mesh network, as will be explained in further detail below.

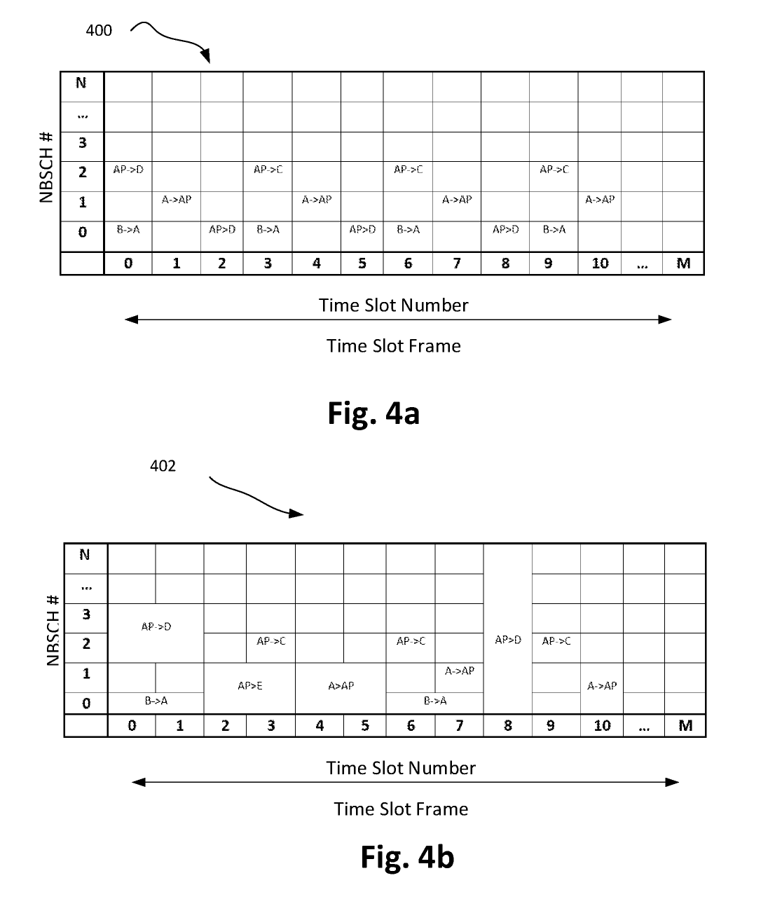

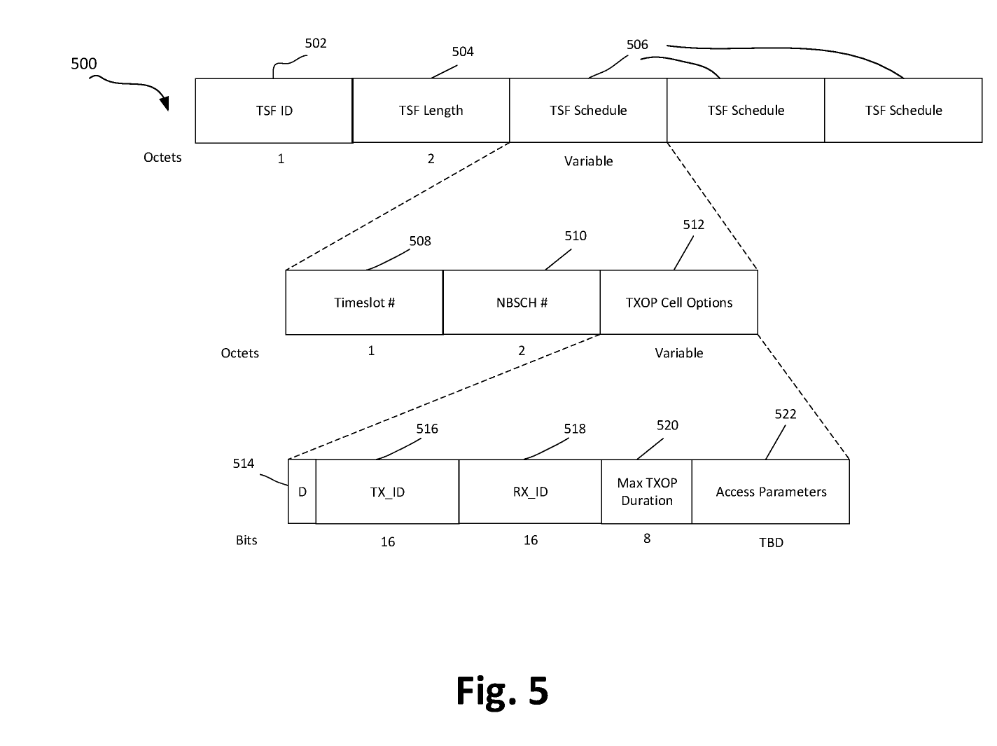

Referring now to FIG. 2, an illustrative narrowband channel allocation is depicted according to some demonstrative embodiments, based on a single wideband frequency channel 202 having a bandwidth of 20 MHz. A device, such as a STA or AP configured to be part of a NB mesh networking system such as the one shown in FIG. 1 may be configured to use the channel 202 by using multiple narrowband subchannels 204 of channel 202 for communication. The use of discrete narrowband channels of a wideband channel in a mesh network may enable a narrowband device that can operate in smaller frequencies to operate with other narrowband devices within the mesh network (such as with IoT devices). According to some demonstrative embodiments, narrowband channels 204 may include one or more narrowband service channels (NBSCH) used for data traffic (e.g., NBSCH 1 . . . x, where x is an integer) and one or more narrowband control channels (NBCCH) (e.g., NBCCH1 . . . y, where y is an integer) used for control and management traffic. Although channel 202 is shown as having bandwidth of 20 MHz divided into nine 2 MHz narrowband channels, it is to be understood that embodiments encompass within their scope the use of channels of any bandwidth where the bandwidth may be divided by devices within a network into any number of narrowband channels. For example, within a wideband channel of 160 MHz, there may be eight 20 MHz narrowband channels. Also, it should be noted that one or more narrowband channels may be combined in order to generate an aggregated narrowband channel, as will be explained in further detail below in relation to FIGS. 4b and 5. The number of NBSCH and NBCCH may be determined by the system, by the AP, or by system administrator preference.

The number of narrowband channels within a frequency band may be determined based on the narrowband devices within the BSS, such as, for example, on device capabilities, device costs, target power consumption and application requirements of the devices. For example, if the requirement is to have a 2 MHz narrowband, in a 20 MHz frequency band, then the number of narrowband data channels may be nine. However, if the requirement is to have smaller than 2 MHz narrowband, in the 20 MHz frequency band, then the number of narrowband data channels may increase. The same is true depending on the frequency band. For example, in a 40 MHz frequency band, there may be a larger number of narrowband data channels. The allocation of the narrowband channels may also be dynamically updated during the network operation, which is not possible with existing technologies.

According to some demonstrative embodiments, an AP, such as AP 104 of FIG. 1, may use a control channel to send and receive control traffic to one or more STAs. According to alternative embodiments, the AP 104 of FIG. 1 may use any channel to send and receive control traffic to one or more STAs, such as, for example, in a deterministic pattern (e.g. through periodic beacon messages in a given channel). For lower power STAs such as IoT STAs, which may operate on narrowband channels, a processing of a wideband control frame may not be possible. An advantage of using narrowband channels as described in the context of FIG. 2 is to allow IoT STAs such as those in FIG. 1 to receive control or management information from an AP, such as AP 104, and to base their subsequent data transmissions based on the control or management information sent by the AP. In addition, advantageously, according to some demonstrative embodiments, a STA outside a coverage area of an AP may be configured to detect and/or receive control traffic from the AP, through one or more relay devices on one or more narrowband channels. According to some demonstrative embodiments, the control information may include information on multi-channel time synchronization between the STAs in order to preserve power at one or more of the STAs. The multi-channel time synchronization may include information from the AP to the STAs regarding a wake-up schedule for the STAs for transmitting their data, and regarding TXOP slot aggregation.

A narrowband device to operate in a mesh network according to some demonstrative embodiments may be configured to communicate over multiple discrete narrowband channels to form a multi-channel mesh network, and to allow an aggregation of multiple ones of the narrowband channel across the frequency and time domains according to network needs. In some time-synchronized multi-channel access protocols, such as IEEE 802.15.4e, STA transmissions are restricted to a given transmission opportunity (TXOP) slot defined in the frequency and time domains. Existing mechanisms for access and transmission rules for scheduled/shared TXOP slots are not flexible enough to support applications with different traffic loads, power requirements, Quality of Service requirements, and/or enhanced distributed channel access (EDCA) categories.

Some demonstrative embodiments provide a STA or AP that is configured to communicate over an aggregation of a plural TXOP slots. Such aggregation may be advantageous in reducing control overhead, especially for applications that tend to generate larger amounts of data. Such applications may for example include low latency, high reliability requirements such as, for example, industrial control and video monitoring/surveillance systems. Some demonstrative embodiments therefore allow supporting STAs having varying latency, reliability and power requirements within the same network, such as the mesh network of FIG. 1. The above advantages of some demonstrative embodiments are all the more desirable since a mix of time critical and delay tolerant/low power applications is expected to become prevalent in future buildings and factories involving IoT devices.

According to some demonstrative embodiments, an AP or STA may facilitate dynamic allocation of the one or more narrowband data channels. For example, according to some demonstrative embodiments, the channels may vary in size based on one or more network requirements. Further, one or more of the narrowband data channels may be allocated for specific type of traffic.

Reference will now be made to FIG. 3. FIG. 3 depicts one embodiment of radio system 300 such as one embodiment of a STA, or one embodiment of a AP, such as AP 104, or any of the STAs shown in FIG. 1, which may be configured to allow the use of aggregated TXOP slots according to some demonstrated embodiments. At certain points within the below description, FIG. 3 will be described in reference to a system such as a STA, while at certain other points within the below description, FIG. 3 will be described in reference to a system such as an AP. The context will however be clear based on the description being provided. Furthermore, in the instant description, “processor” and “processing circuitry” are used interchangeably, and refer to circuitry forming one or more processor “blocks” that provides processing functionality.

FIG. 3 shows a block diagram is shown of a wireless communication radio system 300 such as STA or AP (hereinafter STA/AP) such as any of the STAs or any of the APs of FIG. 1, according to some demonstrative embodiments. A wireless communication system may include a radio card 302 in accordance with some demonstrative embodiments. Radio card 302 may include radio front-end module (FEM) circuitry 304, radio IC circuitry 306 and baseband processor 308. In FIG. 3, it is to be noted that the representation of a single antenna may be interpreted to mean one or more antennas.

FEM circuitry 304 may include Wi-Fi functionality, and may include receive signal path comprising circuitry configured to operate on Wi-Fi signals received from one or more antennas 301, to amplify the received signals and to provide the amplified versions of the received signals to the radio IC circuitry 306 for further processing. FEM circuitry 304 may also include a transmit signal path which may include circuitry configured to amplify signals provided by the radio IC circuitry 306 for wireless transmission by one or more of the antennas 301. The antennas may include directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result.

Radio IC circuitry 306 may include Wi-Fi functionality, and may include a receive signal path which may include circuitry to down-convert signals received from the FEM circuitry 304 and provide baseband signals to baseband processor 308. The radio IC circuitry 306 may also include a transmit signal path which may include circuitry to up-convert baseband signals provided by the baseband processor 308 and provide RF output signals to the FEM circuitry 304 for subsequent wireless transmission by the one or more antennas 301.

Baseband processor 308 may include processing circuitry that provides Wi-Fi functionality. In the instant description, the baseband processor 308 may include a memory 309, such as, for example, a set of RAM arrays in a Fast Fourier Transform or Inverse Fast Fourier Transform block (not shown) of the baseband processor 308. Processing circuitry 310 may include control logic to process the signals received from the receive signal path of the radio IC circuitry 306. Baseband processor 308 is also configured to also generate corresponding baseband signals for the transmit signal path of the radio IC circuitry 306, and may further include physical layer (PHY) and medium access control layer (MAC) circuitry, and may further interface with application processor 311 for generation and processing of the baseband signals and for controlling operations of the radio IC circuitry 306. Referring still to FIG. 3, according to the shown embodiment, a MAC mobility management processor 313 may include a processor having logic to provide a number of higher MAC functionalities. In the alternative, or in conjunction with the MAC mobility management processor 313, some of the higher-level MAC functionalities above may be provided by application processor 311.

In some demonstrative embodiments, the front-end module circuitry 304, the radio IC circuitry 306, and baseband processor 308 may be provided on a single radio card, such as wireless radio card 302. In some other embodiments, the one or more antennas 301, the FEM circuitry 304 and the radio IC circuitry 306 may be provided on discrete/separate cards or platforms. In some other embodiments, the radio IC circuitry 306 and the baseband processor 308 may be provided on a single chip or integrated circuit (IC), such as IC 312. The FEM, radio IC and baseband may be provided on a single chip such as wireless circuit card 360.

In some demonstrative embodiments, the wireless radio card 302 may include a Wi-Fi radio card and may be configured for Wi-Fi communications, although the scope of the embodiments is not limited in this respect. In some other embodiments, the radio card 302 may be configured to transmit and receive signals transmitted using one or more modulation techniques other than OFDM or OFDMA, such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, and On-Off Keying (OOK), although the scope of the embodiments is not limited in this respect.

In some demonstrative embodiments, the system 300 may include other radio cards, such as a cellular radio card 316 configured for cellular (e.g., 3GPP such as LTE, LTE-Advanced or 5G communications).

In some IEEE 802.11 embodiments, the radio card 302 may be configured for communication over various channel bandwidths including bandwidths having center frequencies of 900 MHz, 2.4 GHz, 5 GHz, and bandwidths of less than 5 MHz, or of about 1 MHz, 2 MHz, 2.5 MHz, 4 MHz, 5 MHz, 8 MHz, 10 MHz, 16 MHz, 20 MHz, 40 MHz, 80 MHz (with contiguous bandwidths) or 80+80 MHz (160 MHz) (with non-contiguous bandwidths), or any combination of the above frequencies or bandwidths, or any frequencies or bandwidths between the ones expressly noted above. In some demonstrative embodiments, a 320 MHz channel bandwidth may be used. The scope of the embodiments is not limited with respect to the above center frequencies however.

Referring still to FIG. 3, in some demonstrative embodiments, STA/AP may further include an input unit 318, an output unit 319, a memory unit 315. STA/AP may optionally include other suitable hardware components and/or software components. In some demonstrative embodiments, some or all of the components of STA/AP may be enclosed in a common housing or packaging, and may be interconnected or operably associated using one or more wired or wireless links. In other embodiments, components of STA/AP may be distributed among multiple or separate devices.

In some demonstrative embodiments, application processor 311 may include, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Application processor 311 may execute instructions, for example, of an Operating System (OS) of STA/AP and/or of one or more suitable applications.

In some demonstrative embodiments, input unit 318 may include, for example, one or more input pins on a circuit board, a keyboard, a keypad, a mouse, a touch-screen, a touch-pad, a track-ball, a stylus, a microphone, or other suitable pointing device or input device. Output unit 319 may include, for example, one or more output pins on a circuit board, a monitor, a screen, a touch-screen, a flat panel display, a Light Emitting Diode (LED) display unit, a Liquid Crystal Display (LCD) display unit, a plasma display unit, one or more audio speakers or earphones, or other suitable output devices.

In some demonstrative embodiments, memory 315 may include, for example, a Random-Access Memory (RAM), a Read-Only Memory (ROM), a Dynamic RAM (DRAM), a Synchronous DRAM (SD-RAM), a flash memory, a volatile memory, a non-volatile memory, a cache memory, a buffer, a short-term memory unit, a long-term memory unit, or other suitable memory units. Storage unit 317 may include, for example, a hard disk drive, a floppy disk drive, a Compact Disk (CD) drive, a CD-ROM drive, a DVD drive, or other suitable removable or non-removable storage units. Memory unit 315 and/or storage unit 317, for example, may store data processed by STA/AP.

The system 300 may further include a sensing mechanism 350. For example, the system may include a temperature sending mechanism, a moisture sensing mechanism, a power sensing mechanism, a motion sensing mechanism, or any other sensing mechanism, which may be coupled to the baseband processor 308 and application processor 311 It is noted that, although a number of components are shown in FIG. 3 as being part of system 300, embodiments encompass by way of example, an entirely different system, a system that includes more or different components, a system that omits some of the shown components.

Reference is now made to FIG. 4a, which provides a schematic illustration of a time synchronization function (TSF) schedule information 400. A coordinator device/allocator according to some demonstrative embodiments, such as AP 104 of FIG. 1, or such as one of the STAs of FIG. 1, may send TSF information including a schedule similar to the TSF schedule of FIG. 4a, the TSF information, by virtue of the TSF schedule, including information on a plurality of transmit opportunity (TXOP) slots in a frequency domain and in a time domain. The TSF schedule as shown may include a two-dimensional array having timeslots on the time axis or x axis (time domain) and narrowband service channels (e.g., NBSCH) on the channels axis or y axis (frequency domain), the NBSCH's being adapted to be used for data communication to and from STAs within range of the AP, such as the STAs of FIG. 1 with AP 104. For example, there may be timeslots indicated by timeslot numbers (timeslot #'s) 1, . . . , M, on the time axis, where M is an integer, and there may be narrowband service channels, including NBSCH's having NBSCH numbers (NBSCH #'s) 1, . . . , N, on the channels axis, where N is an integer. The NBSCH's may for example be similar to the NBSCH's shown in FIG. 2 and described above. A coordinator device/coordinator/allocator may use a TSF information element (TSF IE), for example in a beacon, to indicate respective frequency and resource allocations including TXOP slots, each slot having a bandwidth of one of the NBSCH's, and a time duration equal to one of the timeslots. Such resource allocations may be used by receiving STAs and/or by the coordinator device/allocator, such as the AP, to communicate within a BSS. In the shown embodiment of FIG. 4a for example, a coordinator device/allocator, such as AP 104 of FIG. 1, is seen to have allocated TXOP slot as a dedicated slot at time slot # 0 and NBSCH slot # 2 to a transmission between the AP and STA D, and to have allocated TXOP slot as a dedicated slot at time slot # 9 and NBSCH slot # 0 to a mesh communication between STA B and STA A. There may be, according to embodiments, a number of approaches to schedule the TXOP slots to the STAs. For example, in a centralized approach, the AP may be configured to collect topology information on the network by way of each STA sending information about their neighbor STAs and about routing information to their AP, for example by using known routing protocols such as IETF RPL. In this manner, the AP would know which STAs need to communicate, and can build a TSF schedule to assign TXOPs accordingly. As another example, in a distributed approach, each pair of STAs would need to negotiate a TXOP between themselves, and, in such a case, the AP would set an overall TSF schedule, and TXOP assignments could be effected in a distributed manner.

Reference is next made to FIG. 4b, which is similar to FIG. 4a, except that it shows, according to some demonstrative embodiments, a TSF schedule information 402 where subsets of TXOP slots, such as those in FIG. 4a, have been aggregated over the frequency domain across some NBSCH's and over the time domain across some timeslots for communication between an AP and associated STAs, such as BSS 100 of FIG. 1. The TSF schedule information 402 may be sent by a coordinator such as an AP or a STA within a BSS, and may be sent in a TSF IE as will be described further in relation to FIG. 5. A coordinator device/allocator may use a TSF schedule to indicate respective frequency and resource allocations including TXOP slots, each slot having a bandwidth of one of the NBSCH's, and a time duration equal to one of the timeslots, where at least one subset of TXOP slots have been aggregated. Such resource allocations may be used by receiving STAs and/or by the coordinator, such as the AP, to communicate within a BSS. In the shown embodiment of FIG. 4b for example, a coordinator, such as AP 104 of FIG. 1, is seen to have allocated the subset of TXOP slot as a dedicated slot at the following combination of timeslot #'s and NBSCH #'s (with the timeslot #'s appearing first within each parenthesis, followed by the NBSCH #'s) (0; 2), (0; 3); (1; 2) and (1; 3) to a transmission between the AP and STA D, and to have allocated the subset of TXOP slot as a dedicated slot at the following combination of timeslot #'s and NBSCH #'s (6; 0), and (7; 0) as a dedicated slot a mesh communication between STA B and STA A.

More information regarding the TSF IE and the information contained therein will be provided in relation to FIG. 5 further below.

According to some demonstrative embodiments, a STA may be configured to relay information to STAs that may be outside the range of an AP or may have a poor link quality with the AP. The information may include the TSF schedule information as shown in FIG. 4a or 4b. For example, STA A of FIG. 1 may relay the TSF schedule information 402 of FIG. 4b from AP 104 to STA B of FIG. 1. STA B would in this way have information regarding the AP's available TXOP slots, and may generate data frames for transmission over a subset of the TXOP slots aggregated as suggested in FIG. 4b.

According to some demonstrative embodiments, a coordinator device, such as an AP or a STA, may allocate one or more narrowband channels as narrowband control channels. For example, AP may allocate channel 9 to be a control channel associated with control and/or management traffic, such as traffic associated with a TSF IE for example, coming from the AP to the devices within the range of the AP. Further, the AP may allocate channel 7 to be a control channel associated with relaying control traffic and/or management by a relay device. In this way, control/management messages could be communicated between an AP and an edge STA, such as edge STA B, by way of a relay, such as by way of STA A.

As shown in FIG. 4b, multiple transmissions may be possible in different NBSCHs in a given timeslot. For example, multiple transmissions may occur on during timeslot 1 on different NBSCH numbers. It is understood that the above descriptions are for purposes of illustration and are not meant to be limiting.

FIG. 5 depicts a narrowband TSF information element (TSF IE) 500 in the time domain, according to some demonstrative embodiments, the TSF IE including a TSF schedule based on a TSF schedule information similar to the one shown in FIG. 4b. TSF IE 500 may include one or more TSF parameters, such as a TSF ID field 502, which is a logical identifier of the TSF IE. The TSF ID field is useful to identify a particular TSF IE as multiple TSF schedule elements may be created in the same network. The TSF IE 500 may also include a TSF length field 504 that may define the number of timeslots in the TSF IE. The TSF IE 500 may additionally include a TSF schedule element or field 506 per TXOP slot. Each TSF schedule element may provide information on the TSF schedule per TXOP slot, such as, for example, slots within a TSF schedule similar to the one shown in FIG. 4b. There may be as many TSF schedule elements as there are TXOP slots. Therefore, one TSF IE may include multiple TSF schedule elements, with each TSF schedule element describing a given TXOP slot. Each TSF schedule element 506 may include a timeslot number 508, corresponding for example to the timeslot #s shown in the x direction in FIG. 4b, a NBSCH number 510, corresponding for example to the timeslot #'s shown in the y direction in FIG. 4b, and a TXOP cell options information element 512, which may define a set of parameters associated with a given slot or slot in the schedule. In particular, the TXOP cell options information element 512 may include a D field or bit field 514, which may indicate whether the slot is a dedicated slot (e.g. D=1 or D=0) or shared (e.g. D=0 or D=1). For dedicated slots, the TX_ID field 516 and RX_ID field 518 may indicate the address of the STA that is allowed to transmit and receive, respectively. For shared slots, the TX_ID field 516 may be set to a broadcast address. Where slots are to be aggregated for dedicated TXOP slots, multiple TSF schedule elements corresponding to the subset of the TXOP slots to be aggregated may include a TX_ID field indicating a same transmitting STA, and a RX_ID field indicating a same receiving STA. Where slots are to be aggregated for shared TXOP slots, multiple TSF schedule elements corresponding to each subset of the TXOP slots to be aggregated may include a TX_ID field indicating a same multicast or broadcast address, and the RX_ID field may be left blank. STAs receiving TSF schedule elements indicating shared TXOP slots would contend for the medium within the indicated slot resources, such as by using carrier sense multiple access with collision avoidance (CSMA/CA) including a backoff procedure in a well-known manner in order to gain access to the indicated TXOP slots.

According to some demonstrative embodiments, the TSF IE may include the starting time slot number and a narrowband channel bitmap to indicate the channel allocation for an aggregate TXOP transmission. Alternatively, a schedule may be negotiated by a STA in a distributed way as noted above, such as by using a peer to peer messaging protocol. The STA may agree on certain TXOP cells to use, for example based on request/response protocols, such as the IETF 6top (6P) protocol, or any other distributed algorithm, the latter being outside the scope of the instant disclosure.

Referring still to FIG. 5, the TSF Schedule elements 506 may further each include a Maximum TXOP Duration field, the Maximum TXOP Duration field 520 and an Access Parameters field 522. The Maximum TXOP Duration field 520 is to indicate the maximum packet exchange duration allowed in the time domain, whether over a single slot or across aggregated slots. For aggregated slots, its value may exceed a maximum slot size for a single slot in order to enable transmission across slots. Without aggregation, all transmission would be limited by the slot duration of each slot, and one would only need to specify the slot duration as a result. However, when aggregation is enabled, some STAs may be able to use multiple TXOP slots, and one way to refer to the use of the multiple TXOP slots is by providing a maximum TXOP duration for aggregation.

According to some demonstrative embodiments, a TSF schedule element may therefore indicate a TXOP slot as a dedicated slot or a shared slot. A dedicated slot may refer to a slot where a single predetermined STA is allowed to transmit. A shared slot may refer to a slot where multiple STAs may contend for transmission. In dedicated slots, STAs may transmit after a given guard time, meaning no contention would be applicable. In shared slots, STAs may perform clear channel assessment (CCA) on the assigned NBSCH and invoke the backoff procedure, similar to the enhanced distributed channel access (EDCA) access rules for channel contention. Some of the unassigned TXOP slots in the TSF schedule may be used by STAs not scheduled by the coordinator device but that may have some random bursty uplink (UL) traffic to be transmitted to the relay device and finally to the coordinator device.

According to some demonstrative embodiments, a narrowband mesh networking system may define multiple TSF TXOP slots in the same network. However, all TSF TXOP slots may be synchronized to the same timeslot boundary. For instance, a coordinator device may define different TSF slots for different types of application traffic (e.g. upstream, downstream, delay tolerant, delay sensitive, etc.). According to some demonstrative embodiments, different NBSCHs may be used in multiple TSF TXOP slots in the same network. The coordinator device may control the overall time synchronization of the timeslots.

According to some demonstrative embodiments, and as discussed above, the coordinator device may be responsible for generating and transmitting a TSF IE on a NBCCH. According to some demonstrative embodiments, the TSF IE may be transmitted as part of a narrowband trigger frame (NBTF). In another embodiment, the TSF IE may be transmitted as a control or management frame.

According to some demonstrative embodiments, a wireless communication device, such as baseband processor 308 of FIG. 3, including a memory 309 and processing circuitry 310 coupled to the memory, may include logic, and may be configured to process a TSF IE, such as TSF IE 500 in FIG. 5 or TSF IE 402 of FIG. 4b, the TSF IE including information on a plurality of transmit opportunity (TXOP) slots in a frequency domain and in a time domain, the TXOP slots indicating respective narrowband channels of a wideband channel in the frequency domain for communication with the device. The device may “process” the TSF IE for example by processing only portions of the TSF IE relevant to it, or all of the TSF IE. The device may then generate a data frame based on the TSF IE, that is, a data frame configured such that it complies with scheduling information within the TSF IE. The device may then cause transmission of the data frame over a subset of the TXOP slots, such as for example, the subset being aggregated over at least one of the frequency domain and the time domain.

According to some demonstrative embodiments, a wireless communication device, such as baseband processor 308 of FIG. 3, including a memory 309 and processing circuitry 310 coupled to the memory, may include logic, and may be configured to generate a TSF IE such as TSF IE 500 of FIG. 5 or TSF IE 402 of FIG. 4b, the TSF IE including information on a plurality of transmit opportunity (TXOP) slots in a frequency domain and in a time domain. The TXOP slots indicating respective narrowband channels of a wideband channel in the frequency domain for communication with a plurality of wireless communication stations (STAs), wherein the TSF IE further includes an indication that a subset of the TXOP slots, as shown for example in FIG. 4b, are dedicated slots dedicated to a transmission to or from a STA of the plurality of STAs. The processing circuitry is further to cause transmission of the TSF IE to the plurality of STAs.

According to some embodiments, the memory may encompass memory 309 and/or memory 315, and the processing circuitry may encompass processing circuitry 310 of FIG. 3 and/or application processor 311 of FIG. 3. According to some embodiments the wireless communication device may be a system-level device such as the system 300 of FIG. 3.

According to some demonstrative embodiments, the TSF may include an indication that at least some of the TXOP slots are shared slots to be shared among respective ones of a plurality of devices including the device. In such a case, the processing circuitry is further to perform clear channel assessment (CCA) and invoke a backoff procedure on the shared slots to gain access to the subset of TXOP slots.

According to some demonstrative embodiments, the TSF IE may include an indication that at least some of the TXOP slots are dedicated slots dedicated to communication with respective ones of a plurality of devices including the device, and wherein the subset of the TXOP slots is included within the dedicated slots for the device. The TSF IE may further include an indication that some of the TXOP slots are dedicated slots, while some other ones are shared slots. The subset of TXOP slots may include TXOP slots that are adjacent to one another in at least one of the frequency domain and the time domain, as shown in FIG. 4b. However, embodiments include within their scope aggregated TXOP slots that are not adjacent in either the frequency domain and/or in the time domain. The processing circuitry may for example base an allocation of TXOP slots for transmission of the data frame on at least one of quality of service (QoS) requirements for the data frame for example based on access category, power requirements for the data frame, and traffic load on the narrowband channels. For example, a STA with high priority asynchronous traffic may aggregate multiple slots or cells in a time domain, and this may be indicated to a receiver by a duration field of a data transmission that is part of that traffic. For example, only a specific access category value mapped to the high priority traffic may be allowed to transmit across aggregated TXOP slots. The above may be true for shared TXOP slots. In such a case, where a high priority STA transmits across aggregated TXOP slots or cells, other contending STAs will back off once their CCA detects the medium busy. Embodiments envisage a definition of a maximum number of aggregated shared slots in order to prevent unfair channel acquisition.

According to some demonstrative embodiments, the TSF IE may further be on a narrowband control channel, the device further including a radio integrated circuit to receive the TSF IE over a narrowband control channel, and to switch to one or more narrowband service channels to transmit the data frame.

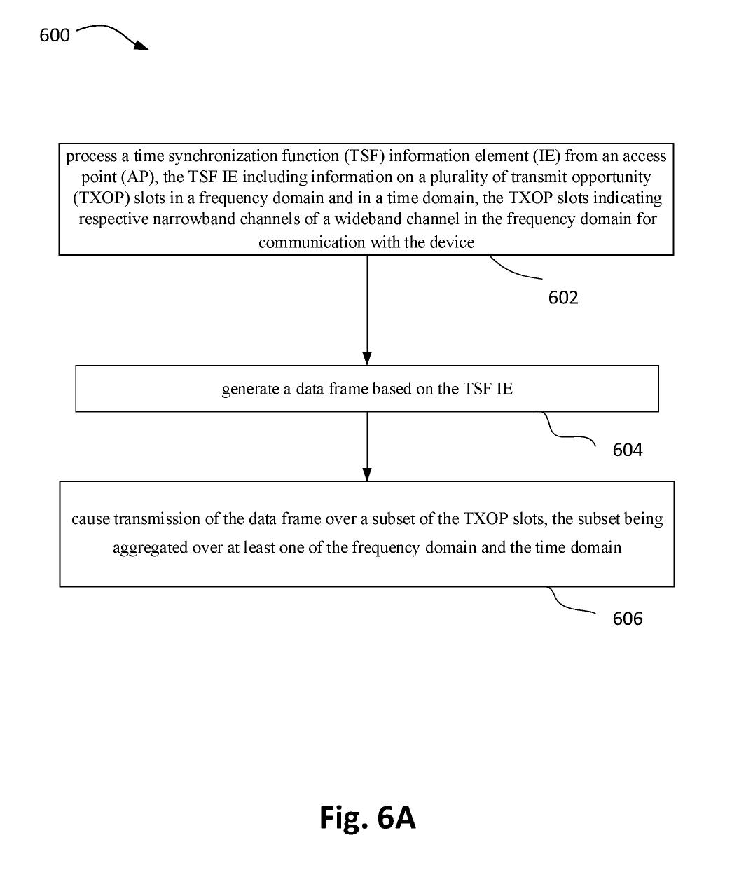

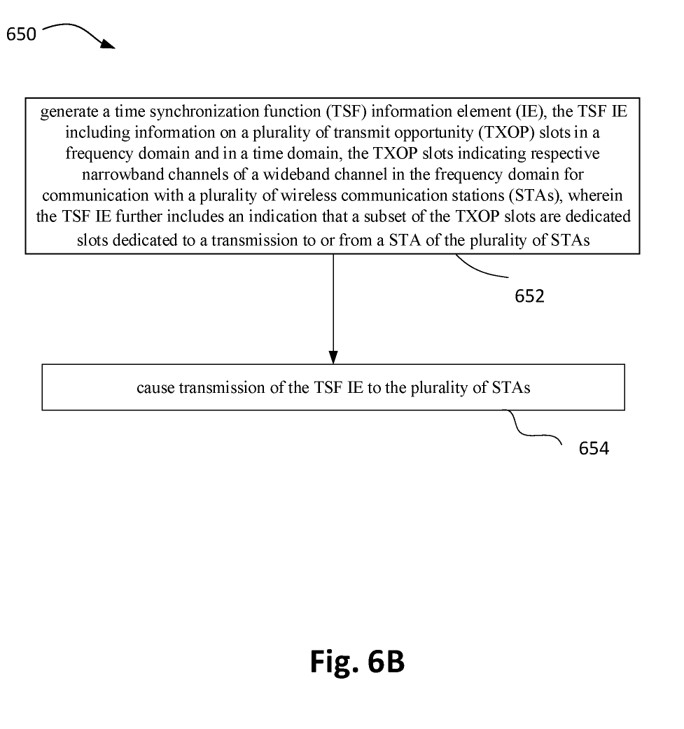

FIG. 6A illustrates a flow diagram of illustrative process 600 according to some demonstrative embodiments. The process of FIG. 6A may for example be performed by a wireless communication device, such as a baseband processor, or a larger system, such as a STA. At block 602, the process includes processing a time synchronization function (TSF) IE from an access point (AP), the TSF IE including information on a plurality of transmit opportunity (TXOP) slots in a frequency domain and in a time domain, the TXOP slots indicating respective narrowband channels of a wideband channel in the frequency domain for communication with the device. At block 604, the process further includes generating a data frame based on the TSF IE. At block 606, the process includes causing transmission of the data frame over a subset of the TXOP slots, the subset being aggregated over at least one of the frequency domain and the time domain.

FIG. 6B illustrates a flow diagram of illustrative process 650 according to some demonstrative embodiments. The process of FIG. 6B may for example be performed by a wireless communication device, such as a baseband processor, or a larger system, such as a STA or an AP. At block 652, the process includes generating a time synchronization function (TSF) IE, the TSF IE including information on a plurality of transmit opportunity (TXOP) slots in a frequency domain and in a time domain, the TXOP slots indicating respective narrowband channels of a wideband channel in the frequency domain for communication with a plurality of wireless communication stations (STAs), wherein the TSF IE further includes an indication that a subset of the TXOP slots are dedicated slots dedicated to a data transmission to or from a STA of the plurality of STAs. At block 654, the process further includes causing transmission of the TSF IE to the plurality of STAs.

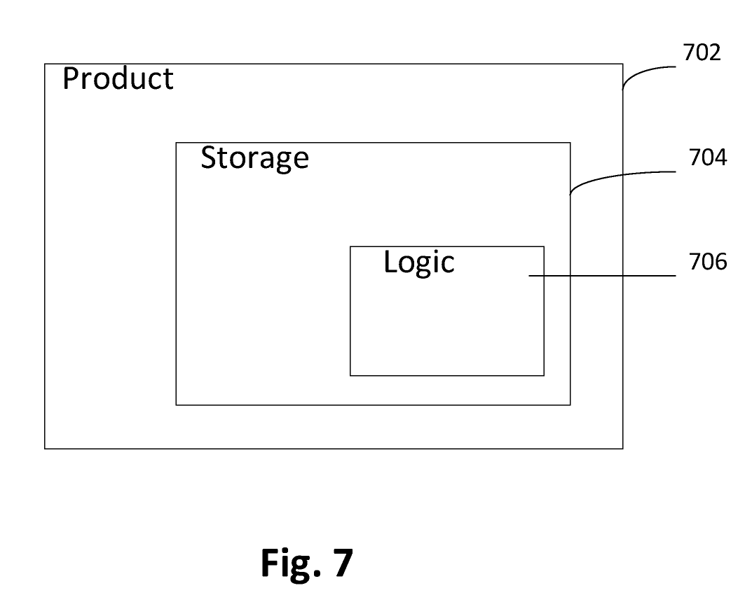

FIG. 7 illustrates a product of manufacture 702, in accordance with some demonstrative embodiments. Product 702 may include one or more tangible computer-readable non-transitory storage media 704, which may include computer-executable instructions, e.g., implemented by logic 706, operable to, when executed by at least one computer processor, enable the at least one computer processor to implement one or more operations at one or more STAs or APs, and/or to perform one or more operations described above with respect to FIGS. 1-6B, and/or one or more operations described herein. The phrase “non-transitory machine-readable medium” is directed to include all computer-readable media, with the sole exception being a transitory propagating signal.

In some demonstrative embodiments, product 702 and/or storage media 704 may include one or more types of computer-readable storage media capable of storing data, including volatile memory, non-volatile memory, removable or non-removable memory, erasable or non-erasable memory, writeable or re-writeable memory, and the like. For example, storage media 704 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), Compact Disk ROM (CD-ROM), Compact Disk Recordable (CD-R), Compact Disk Rewriteable (CD-RW), flash memory (e.g., NOR or NAND flash memory), content addressable memory (CAM), polymer memory, phase-change memory, ferroelectric memory, silicon-oxide-nitride-oxide-silicon (SONOS) memory, a disk, a floppy disk, a hard drive, an optical disk, a magnetic disk, a card, a magnetic card, an optical card, a tape, a cassette, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative embodiments, logic 706 may include instructions, data, and/or code, which, if executed by a machine, may cause the machine to perform a method, process and/or operations as described herein. The machine may include, for example, any suitable processing platform, computing platform, computing device, processing circuitry, computing system, processing system, computer, processor, or the like, and may be implemented using any suitable combination of hardware, software, firmware, and the like.

In some demonstrative embodiments, logic 706 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, such as C, C++, Java, BASIC, Matlab, Pascal, Visual BASIC, assembly language, machine code, and the like.

The terms “plurality” and “a plurality”, as used herein, include, for example, “multiple” or “two or more”. For example, “a plurality of items” includes two or more items.

References to “one embodiment”, “an embodiment”, “demonstrative embodiment”, “various embodiments” etc., indicate that the embodiment(s) so described may include a particular feature, structure, or characteristic, but not every embodiment necessarily includes the particular feature, structure, or characteristic. Further, repeated use of the phrase “according to some demonstrative embodiments” does not necessarily refer to the same embodiment, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

Some embodiments may be used in conjunction with various devices and systems, for example, a User Equipment (UE), a Mobile Device (MD), a wireless station (STA), a Personal Computer (PC), a desktop computer, a mobile computer, a laptop computer, a notebook computer, a tablet computer, a server computer, a handheld computer, a handheld device, a wearable device, a sensor device, an Internet of Things (IoT) device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some embodiments may be used in conjunction with devices and/or networks operating in accordance with existing and/or published IEEE 802.11 standards or amendments (including IEEE 802.11ax, IEEE 802.11-2012 (IEEE 802.11-2012, IEEE Standard for Information technology—Telecommunications and information exchange between systems Local and metropolitan area networks—Specific requirements Part 11: Wireless LAN Medium Access Control (MAC) and Physical Layer (PHY) Specifications, Mar. 29, 2012); IEEE802.11ac-2013 (“IEEE P802.11ac-2013, IEEE Standard for Information Technology—Telecommunications and Information Exchange Between Systems—Local and Metropolitan Area Networks—Specific Requirements—Part 11: Wireless LAN Medium Access Control (MAC) and Physical Layer (PHY) Specifications—Amendment 4: Enhancements for Very High Throughput for Operation in Bands below 6 GHz”, December, 2013); IEEE 802.11ad (“IEEE P802.11ad-2012, IEEE Standard for Information Technology—Telecommunications and Information Exchange Between Systems—Local and Metropolitan Area Networks—Specific Requirements—Part 11: Wireless LAN Medium Access Control (MAC) and Physical Layer (PHY) Specifications—Amendment 3: Enhancements for Very High Throughput in the 60 GHz Band”, 28 Dec., 2012); IEEE-802.11REVmc (“IEEE 802.11-REVmc™/D3.0, June 2014 draft standard for Information technology—Telecommunications and information exchange between systems Local and metropolitan area networks Specific requirements; Part 11: Wireless LAN Medium Access Control (MAC) and Physical Layer (PHY) Specification”); IEEE 802.11ax (IEEE 802.11ax, High Efficiency WLAN (HEW)); IEEE802.11-ay (P802.11ay Standard for Information Technology—Telecommunications and Information Exchange Between Systems Local and Metropolitan Area Networks—Specific Requirements Part 11: Wireless LAN Medium Access Control (MAC) and Physical Layer (PHY) Specifications—Amendment: Enhanced Throughput for Operation in License-Exempt Bands Above 45 GHz)) and/or future versions and/or derivatives thereof) and/or future versions and/or derivatives thereof, devices and/or networks operating in accordance with existing Wireless-Gigabit-Alliance (WGA) specifications (Wireless Gigabit Alliance, Inc WiGig MAC and PHY Specification Version 1.1, April 2011, Final specification) and/or future versions and/or derivatives thereof, devices and/or networks operating in accordance with existing Wireless Fidelity (Wi-Fi) Alliance (WFA) Peer-to-Peer (P2P) specifications (Wi-Fi P2P technical specification, version 1.5, Aug. 4, 2014) and/or future versions and/or derivatives thereof, devices and/or networks operating in accordance with existing cellular specifications and/or protocols, e.g., 3rd Generation Partnership Project (3GPP), 3GPP Long Term Evolution (LTE) and/or future versions and/or derivatives thereof, devices and/or networks operating in accordance with existing Bluetooth (BT) specifications and/or protocols and/or future versions and/or derivatives thereof, units and/or devices which are part of the above networks, and the like.

Some embodiments may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some embodiments may be used in conjunction with one or more types of wireless communication signals and/or systems, for example, Radio Frequency (RF), Infra Red (IR), Frequency-Division Multiplexing (FDM), Orthogonal FDM (OFDM), Orthogonal Frequency-Division Multiple Access (OFDMA), FDM Time-Division Multiplexing (TDM), Time-Division Multiple Access (TDMA), Multi-User MIMO (MU-MIMO), Spatial Division Multiple Access (SDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), Global System for Mobile communication (GSM), 2G, 2.5G, 3G, 3.5G, 4G, Fifth Generation (5G), or Sixth Generation (6G) mobile networks, 3GPP, Long Term Evolution (LTE), LTE advanced, Enhanced Data rates for GSM Evolution (EDGE), or the like. Other embodiments may be used in various other devices, systems and/or networks.

The term “wireless communication device”, as used herein, includes, for example, a device capable of causing wireless communication, a communication station capable of wireless communication, a portable or non-portable device capable of wireless communication, or the like. In some demonstrative embodiments, a wireless device may be or may include a peripheral that is integrated with a computer, or a peripheral that is attached to a computer. In some demonstrative embodiments, the term “wireless communication device” may optionally include a wireless service. Wireless communication devices or systems may include, for example, a UE, an MD, a STA, an AP, a PC, a desktop computer, a mobile computer, a laptop computer, an Ultrabook™ computer, a notebook computer, a tablet computer, a server computer, a handheld computer, an Internet of Things (IoT) device, a sensor device, a handheld device, a wearable device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “Carry Small Live Large” (CSLL) device, an Ultra Mobile Device (UMD), an Ultra Mobile PC (UMPC), a Mobile Internet Device (MID), an “Origami” device or computing device, a device that supports Dynamically Composable Computing (DCC), a context-aware device, a video device, an audio device, an A/V device, a Set-Top-Box (STB), a Blu-ray disc (BD) player, a BD recorder, a Digital Video Disc (DVD) player, a High Definition (HD) DVD player, a DVD recorder, a HD DVD recorder, a Personal Video Recorder (PVR), a broadcast HD receiver, a video source, an audio source, a video sink, an audio sink, a stereo tuner, a broadcast radio receiver, a flat panel display, a Personal Media Player (PMP), a digital video camera (DVC), a digital audio player, a speaker, an audio receiver, an audio amplifier, a gaming device, a data source, a data sink, a Digital Still camera (DSC), a media player, a Smartphone, a television, a music player, or the like.

The term “communicating” as used herein with respect to a communication signal includes transmitting the communication signal and/or receiving the communication signal. For example, a communication unit, which is capable of communicating a communication signal, may include a transmitter to transmit the communication signal to at least one other communication unit, and/or a communication receiver to receive the communication signal from at least one other communication unit. The verb communicating may be used to refer to the action of transmitting or the action of receiving. In one example, the phrase “communicating a signal” may refer to the action of transmitting the signal by a first device, and may not necessarily include the action of receiving the signal by a second device. In another example, the phrase “communicating a signal” may refer to the action of receiving the signal by a first device, and may not necessarily include the action of transmitting the signal by a second device.

As used herein, the term “circuitry” may refer to, be part of, or include, an Application Specific Integrated Circuit (ASIC), an integrated circuit, an electronic circuit, one or more processors (shared, dedicated, or group), and/or memory (shared, dedicated, or group), that execute one or more software or firmware programs, a combinational logic circuit, and/or other suitable hardware components that provide the described functionality. In some embodiments, the circuitry may be implemented in, or functions associated with the circuitry may be implemented by, one or more software or firmware modules. In some embodiments, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute or implement the computing logic to perform computing functions and/or operations. In one example, logic may be embedded in various types of memory and/or firmware, e.g., silicon blocks of various chips and/or processors. Logic may be included in, and/or implemented as part of, various circuitry, e.g. radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and the like. Logic may be executed by one or more processors using memory, e.g., registers, stuck, buffers, and/or the like, coupled to the one or more processors, e.g., as necessary to execute the logic.

Some demonstrative embodiments may be used in conjunction with a WLAN, e.g., a Wi-Fi network. Other embodiments may be used in conjunction with any other suitable wireless communication network, for example, a wireless area network, a “piconet”, a WPAN, a WVAN and the like.

Some demonstrative embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. Those instructions may then be read and executed by one or more processors to cause the device 300 of FIG. 3 to perform the methods and/or operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

### EXAMPLES

The following examples pertain to further embodiments.

Example 1 includes a wireless communication device including a memory and processing circuitry coupled to the memory, the processing circuitry comprising logic to: process a time synchronization function (TSF) information element (IE) from an access point (AP), the TSF IE including information on a plurality of transmit opportunity (TXOP) slots in a frequency domain and in a time domain, the TXOP slots indicating respective narrowband channels of a wideband channel in the frequency domain for communication with the device; generate a data frame based on the TSF IE; cause transmission of the data frame over a subset of the TXOP slots, the subset being aggregated over at least one of the frequency domain and the time domain.

Example 2 includes the subject matter of Example 1, and optionally, wherein the respective narrowband channels include narrowband service channels.

Example 3 includes the subject matter of Example 1, and optionally, wherein the TSF IE includes an indication that at least some of the TXOP slots are shared slots to be shared among respective ones of a plurality of devices including the device, and wherein the processing circuitry is further to perform clear channel assessment (CCA) and invoke a backoff procedure on the shared slots to gain access to the subset of TXOP slots.

Example 4 includes the subject matter of Example 3, and optionally, wherein the TSF IE includes an indication that at least some of the TXOP slots are dedicated slots dedicated to communication with respective ones of a plurality of devices including the device, and wherein the subset of the TXOP slots is included within the dedicated slots for the device.

Example 5 includes the subject matter of any one of Examples 1-4, and optionally, wherein the subset of TXOP slots includes TXOP slots that are adjacent to one another in at least one of the frequency domain and the time domain.

Example 6 includes the subject matter of any one of Examples 1-4, and optionally, wherein the processing circuitry is to cause transmission of the data frame over the subset of the TXOP slots based on at least one of quality of service (QoS) requirements for the data frame, power requirements for the data frame, and traffic load on the narrowband channels.

Example 7 includes the subject matter of any one of Examples 1-4, and optionally, wherein the device is a first device configured to relay the TSF IE from the AP to a second device that is outside a range of the AP and within a range of the first device.

Example 8 includes the subject matter of any one of Examples 1-4, and optionally, wherein the TSF IE is included in one of a beacon frame, a trigger frame, or a management frame.

Example 9 includes the subject matter of any one of Examples 1-4, and optionally, wherein the TSF IE includes a plurality of TSF schedule elements, the TSF schedule elements including the information on the plurality of transmit opportunity (TXOP) slots.

Example 10 includes the subject matter of Example 9, and optionally, wherein the TSF IE includes a starting time slot number and narrowband channel bitmap to indicate the subset of TXOP slots.

Example 11 includes the subject matter of Example 9, and optionally, wherein each TSF schedule element further includes a Maximum TXOP Duration field, the Maximum TXOP Duration field indicating the maximum packet exchange duration allowed in the time domain for the aggregated subset of TXOP slots.

Example 12 includes the subject matter of Example 9, and optionally, wherein each TSF schedule element includes a TXOP bit field to indicate whether at least some of the TXOP slots are shared slots to be shared among respective ones of a plurality of devices including the device, or dedicated slots dedicated to communication with respective ones of a plurality of devices including the device.

Example 13 includes the subject matter of any one of Examples 1-4, and optionally, the TSF IE further being on a narrowband control channel, the device further including a radio integrated circuit to receive the TSF IE over a narrowband control channel, and to switch to one or more narrowband service channels to transmit the data frame.

Example 14 includes the subject matter of Example 13, and optionally, further comprising one or more antennas coupled to the radio integrated circuit.

Example 15 includes method to be performed at a wireless communication device, the method including: processing a time synchronization function (TSF) information element (IE) from an access point (AP), the TSF IE including information on a plurality of transmit opportunity (TXOP) slots in a frequency domain and in a time domain, the TXOP slots indicating respective narrowband channels of a wideband channel in the frequency domain for communication with the device; generating a data frame based on the TSF IE; causing transmission of the data frame over a subset of the TXOP slots, the subset being aggregated over at least one of the frequency domain and the time domain.

Example 16 includes the subject matter of Example 15, and optionally, wherein the respective narrowband channels include narrowband service channels.

Example 17 includes the subject matter of Example 15, and optionally, wherein the TSF IE includes an indication that at least some of the TXOP slots are shared slots to be shared among respective ones of a plurality of devices including the device, and wherein the method further includes performing clear channel assessment (CCA) and invoke a backoff procedure on the shared slots to gain access to the subset of TXOP slots.

Example 18 includes the subject matter of Example 15, and optionally, wherein the TSF includes an indication that at least some of the TXOP slots are dedicated slots dedicated to communication with respective ones of a plurality of devices including the device, and wherein the subset of the TXOP slots is included within the dedicated slots for the device.

Example 19 includes the subject matter of Example 15, and optionally, wherein the subset of TXOP slots includes TXOP slots that are adjacent to one another in at least one of the frequency domain and the time domain.

Example 20 includes the subject matter of any one of Examples 15-19, and optionally, wherein the method further includes causing transmission of the data frame over the subset of the TXOP slots based on at least one of quality of service (QoS) requirements for the data frame, power requirements for the data frame, and traffic load on the narrowband channels.

Example 21 includes the subject matter of any one of Examples 15-19, and optionally, wherein the device is a first device, the method further including relaying the TSF IE from the AP to another device that is outside a range of the AP and within a range of the first device.

Example 22 includes the subject matter of any one of Examples 15-19, and optionally, wherein the TSF IE is one of a beacon frame, a trigger frame, or a management frame.

Example 23 includes the subject matter of any one of Examples 15-19, and optionally, wherein the TSF IE includes a plurality of TSF schedule elements, the TSF schedule elements including the information on the plurality of transmit opportunity (TXOP) slots.

Example 24 includes the subject matter of Example 23, wherein each TSF schedule element includes a starting time slot number and narrowband channel bitmap to indicate the subset of TXOP slots.

Example 25 includes the subject matter of Example 23, and optionally, wherein each TSF schedule element further includes a Maximum TXOP Duration field, the Maximum TXOP Duration field indicating the maximum packet exchange duration allowed in the time domain for the aggregated subset of TXOP slots.

Example 26 includes the subject matter of Example 23, and optionally, wherein each TSF schedule element includes a TXOP bit field to indicate whether at least some of the TXOP slots are shared slots to be shared among respective ones of a plurality of devices including the device, or dedicated slots dedicated to communication with respective ones of a plurality of devices including the device.

Example 27 includes the subject matter of any one of Examples 15-19, and optionally, the TSF IE further being on a narrowband control channel and the data frame being on one or more narrowband service channels, the method further including using a radio integrated circuit of the device to switch between the narrowband control channel and the narrowband service channels to receive the TSF IE and to transmit the data frame, respectively.

Example 28 includes a product comprising one or more tangible computer-readable non-transitory storage media comprising computer-executable instructions operable to, when executed by at least one computer processor, cause the at least one computer processor to implement operations at a wireless communication device, the operations comprising: processing a time synchronization function (TSF) information element (IE) from an access point (AP), the TSF IE including information on a plurality of transmit opportunity (TXOP) slots in a frequency domain and in a time domain, the TXOP slots indicating respective narrowband channels of a wideband channel in the frequency domain for communication with the device; generating a data frame based on the TSF; causing transmission of the data frame over a subset of the TXOP slots, the subset being aggregated over at least one of the frequency domain and the time domain.

Example 29 includes the subject matter of Example 28, and optionally, wherein the respective narrowband channels include narrowband service channels.

Example 30 includes the subject matter of Example 28, and optionally, wherein the TSF IE includes an indication that at least some of the TXOP slots are shared slots to be shared among respective ones of a plurality of devices including the device, and wherein the operations further include performing clear channel assessment (CCA) and invoke a backoff procedure on the shared slots to gain access to the subset of TXOP slots.

Example 31 includes the subject matter of Example 28, and optionally, wherein the TSF IE includes an indication that at least some of the TXOP slots are dedicated slots dedicated to communication with respective ones of a plurality of devices including the device, and wherein the subset of the TXOP slots is included within the dedicated slots for the device.

Example 32 includes the subject matter of Example 28, and optionally, wherein the subset of TXOP slots includes TXOP slots that are adjacent to one another in at least one of the frequency domain and the time domain.

Example 33 includes the subject matter of any one of Examples 28-32, wherein the operations further include causing transmission of the data frame over the subset of the TXOP slots based on at least one of quality of service (QoS) requirements for the data frame, power requirements for the data frame, and traffic load on the narrowband channels.

Example 34 includes the subject matter of any one of Examples 28-32, wherein the operations further include relaying the TSF IE from the AP to another device that is outside a range of the AP.

Example 35 includes the subject matter of any one of Examples 28-32, wherein the TSF IE is one of a beacon frame, a trigger frame, or a management frame.

Example 36 includes the subject matter of any one of Examples 28-32, wherein the TSF includes a plurality of TSF schedule elements TSF schedule element), the TSF schedule elements including the information on the plurality of transmit opportunity (TXOP) slots.

Example 37 includes the subject matter of Example 36, and optionally, wherein each TSF schedule element includes a starting time slot number and narrowband channel bitmap to indicate the subset of TXOP slots.

Example 38 includes the subject matter of Example 36, and optionally, wherein each TSF schedule element further includes a Maximum TXOP Duration field, the Maximum TXOP Duration field indicating the maximum packet exchange duration allowed in the time domain for the aggregated subset of TXOP slots.

Example 39 includes the subject matter of Example 36, and optionally, wherein each TSF schedule element includes a TXOP bit field to indicate whether at least some of the TXOP slots are shared slots to be shared among respective ones of a plurality of devices including the device, or dedicated slots dedicated to communication with respective ones of a plurality of devices including the device.

Example 40 includes the subject matter of any one of Examples 28-32, the TSF IE further being on a narrowband control channel and the data frame being on one or more narrowband service channels, the operations further including using a radio integrated circuit of the device to switch between the narrowband control channel and the narrowband service channels to receive the TSF IE and to transmit the data frame, respectively.

Example 41 includes a wireless communication device including a memory and processing circuitry coupled to the memory, the processing circuitry comprising logic to: generate a time synchronization function (TSF) information element (IE), the TSF IE including information on a plurality of transmit opportunity (TXOP) slots in a frequency domain and in a time domain, the TXOP slots indicating respective narrowband channels of a wideband channel in the frequency domain for communication with a plurality of wireless communication stations (STAs), wherein the TSF IE further includes an indication that a subset of the TXOP slots are dedicated slots dedicated to a transmission to or from a STA of the plurality of STAs; cause transmission of the TSF IE to the plurality of STAs.

Example 42 includes the subject matter of Example 41, and optionally, wherein the respective narrowband channels include narrowband service channels.

Example 43 includes the subject matter of Example 41, and optionally, wherein the TSF includes an indication that at least some of the TXOP slots are shared slots to be shared among respective ones of a plurality of STAs not including the STA.

Example 44 includes the subject matter of any one of Examples 41-43, and optionally, wherein the subset of TXOP slots includes TXOP slots that are adjacent to one another in at least one of the frequency domain and the time domain.

Example 45 includes the subject matter of any one of Examples 41-43, and optionally, wherein the TSF is one of a beacon frame, a trigger frame, or a management frame.

Example 46 includes the subject matter of any one of Examples 41-43, and optionally, wherein the TSF includes a Time synchronization function Schedule Information Element (TSF schedule element), the TSF schedule element including the information on the plurality of transmit opportunity (TXOP) slots.

Example 47 includes the subject matter of Example 46, and optionally, wherein the TSF schedule element includes a starting time slot number and narrowband channel bitmap to indicate the subset of TXOP slots.

Example 48 includes the subject matter of Example 46, and optionally, wherein the TSF schedule element further includes a Maximum TXOP Duration field, the Maximum TXOP Duration field indicating the maximum packet exchange duration allowed in the time domain for the aggregated subset of TXOP slots.

Example 49 includes the subject matter of Example 46, and optionally, wherein the TSF schedule element includes a TXOP bit field to indicate whether at least some of the TXOP slots are shared slots to be shared among respective ones of a plurality of devices including the device, or dedicated slots dedicated to communication with respective ones of a plurality of devices including the device.

Example 50 includes the subject matter of any one of Examples 41-43, and optionally, wherein the device further including a radio integrated circuit to transmit the TSF IE over a narrowband control channel, and to switch to one or more narrowband service channels to transmit or receive data frames.

Example 51 includes the subject matter of Example 50, and optionally, further comprising one or more antennas coupled to the radio integrated circuit.

Example 52 includes a method to be performed at a wireless communication device, the method including: generating a time synchronization function (TSF) information element (IE), the TSF IE including information on a plurality of transmit opportunity (TXOP) slots in a frequency domain and in a time domain, the TXOP slots indicating respective narrowband channels of a wideband channel in the frequency domain for communication with a plurality of wireless communication stations (STAs), wherein the TSF IE further includes an indication that a subset of the TXOP slots are dedicated slots dedicated to a data transmission to or from a STA of the plurality of STAs; and causing transmission of the TSF IE to the plurality of STAs.

Example 53 includes the subject matter of Example 52, and optionally, wherein the respective narrowband channels include narrowband service channels.

Example 54 includes the subject matter of Example 52, and optionally, wherein the TSF IE includes an indication that at least some of the TXOP slots are shared slots to be shared among respective ones of a plurality of STAs not including the STA.

Example 55 includes the subject matter of any one of Examples 52-54, and optionally, wherein the subset of TXOP slots includes TXOP slots that are adjacent to one another in at least one of the frequency domain and the time domain.

Example 56 includes the subject matter of any one of Examples 52-54, and optionally, wherein the TSF IE is one of a beacon frame, a trigger frame, or a management frame.

Example 57 includes the subject matter of any one of Examples 52-54, and optionally, wherein the TSF IE includes a plurality of TSF schedule elements, the TSF schedule elements including the information on the plurality of transmit opportunity (TXOP) slots.

Example 58 includes the subject matter of Example 57, and optionally, wherein each TSF schedule element includes a starting time slot number and narrowband channel bitmap to indicate the subset of TXOP slots.

Example 59 includes the subject matter of Example 57, and optionally, wherein each TSF schedule element further includes a Maximum TXOP Duration field, the Maximum TXOP Duration field indicating the maximum packet exchange duration allowed in the time domain for the aggregated subset of TXOP slots.

Example 60 includes the subject matter of Example 57, and optionally, wherein each TSF schedule element includes a TXOP bit field to indicate whether at least some of the TXOP slots are shared slots to be shared among respective ones of a plurality of devices including the device, or dedicated slots dedicated to communication with respective ones of a plurality of devices including the device.

Example 61 includes the subject matter of any one of Examples 52-54 (and optionally, 52), further including switching between a narrowband control channel to transmit the TSF IE and one or more narrowband service channels to transmit or receive the data transmission.

Example 62 includes a product comprising one or more tangible computer-readable non-transitory storage media comprising computer-executable instructions operable to, when executed by at least one computer processor, cause the at least one computer processor to implement operations at a wireless communication device, the operations comprising generating a time synchronization function (TSF) information element (IE), the TSF IE including information on a plurality of transmit opportunity (TXOP) slots in a frequency domain and in a time domain, the TXOP slots indicating respective narrowband channels of a wideband channel in the frequency domain for communication with a plurality of wireless communication stations (STAs), wherein the TSF IE further includes an indication that a subset of the TXOP slots are dedicated slots dedicated to a transmission to or from a STA of the plurality of STAs; causing transmission of the TSF IE to the plurality of STAs.

Example 63 includes the subject matter of Example 62, and optionally, wherein the respective narrowband channels include narrowband service channels.

Example 64 includes the subject matter of Example 62, and optionally, wherein the TSF IE includes an indication that at least some of the TXOP slots are shared slots to be shared among respective ones of a plurality of STAs not including the STA.

Example 65 includes the subject matter of any one of Examples 62-64, wherein the subset of TXOP slots includes TXOP slots that are adjacent to one another in at least one of the frequency domain and the time domain.

Example 66 includes the subject matter of any one of Examples 62-64, wherein the TSF IE is one of a beacon frame, a trigger frame, or a management frame.

Example 67 includes the subject matter of any one of Examples 62-64, wherein the TSF includes a plurality of time schedule elements, the TSF schedule elements including the information on the plurality of transmit opportunity (TXOP) slots.

Example 68 includes the subject matter of Example 67, and optionally, wherein each TSF schedule element includes a starting time slot number and narrowband channel bitmap to indicate the subset of TXOP slots.

Example 69 includes the subject matter of Example 67, and optionally, wherein each TSF schedule element further includes a Maximum TXOP Duration field, the Maximum TXOP Duration field indicating the maximum packet exchange duration allowed in the time domain for the aggregated subset of TXOP slots.

Example 70 includes the subject matter of Example 67, and optionally, wherein each TSF schedule element includes a TXOP bit field to indicate whether at least some of the TXOP slots are shared slots to be shared among respective ones of a plurality of devices including the device, or dedicated slots dedicated to communication with respective ones of a plurality of devices including the device.

Example 71 includes the subject matter of any one of Examples 62-64, the device further including a radio integrated circuit to transmit the TSF IE over a narrowband control channel, and to switch to one or more narrowband service channels to transmit or receive data frames.

Example 72 includes the subject matter of Example 71, and optionally, further comprising one or more antennas coupled to the radio integrated circuit.

An Abstract is provided. It is submitted with the understanding that it will not be used to limit or interpret the scope or meaning of the claims. The following claims are hereby incorporated into the detailed description, with each claim standing on its own as a separate embodiment.

What is claimed is:

1. A wireless communication device including a memory and processing circuitry coupled to the memory, the processing circuitry comprising logic to:
process a time synchronization function (TSF) information element (IE) from an access point (AP), the TSF IE including information on a plurality of transmit opportunity (TXOP) slots in a frequency domain and in a time domain, the TXOP slots indicating respective narrowband channels of a wideband channel in the frequency domain for communication with the device;
generate a data frame based on the TSF IE;
cause transmission of the data frame over a subset of the TXOP slots, the subset being aggregated over at least one of the frequency domain and the time domain.

2. The device of claim 1, wherein the TSF IE includes an indication that at least some of the TXOP slots are shared slots to be shared among respective ones of a plurality of devices including the device, and wherein the processing circuitry is further to perform clear channel assessment (CCA) and invoke a backoff procedure on the shared slots to gain access to the subset of TXOP slots.

3. The device of claim 2, wherein the TSF IE includes an indication that at least some of the TXOP slots are dedicated slots dedicated to communication with respective ones of a plurality of devices including the device, and wherein the subset of the TXOP slots is included within the dedicated slots for the device.

4. The device of claim 1, wherein the subset of TXOP slots includes TXOP slots that are adjacent to one another in at least one of the frequency domain and the time domain.

5. The device of claim 1, wherein the processing circuitry is to cause transmission of the data frame over the subset of the TXOP slots based on at least one of quality of service (QoS) requirements for the data frame, power requirements for the data frame, and traffic load on the narrowband channels.

6. The device of claim 1, wherein the device is a first device configured to relay the TSF IE from the AP to a second device that is outside a range of the AP and within a range of the first device.

7. The device of claim 1, wherein the TSF IE includes a plurality of TSF schedule elements, the TSF schedule elements including the information on the plurality of transmit opportunity (TXOP) slots.

8. The device of claim 7, wherein the TSF IE includes a starting time slot number and narrowband channel bitmap to indicate the subset of TXOP slots.

9. The device of claim 7, wherein each TSF schedule element further includes a Maximum TXOP Duration field, the Maximum TXOP Duration field indicating the maximum packet exchange duration allowed in the time domain for the aggregated subset of TXOP slots.

10. The device of claim 7, wherein each TSF schedule element includes a TXOP bit field to indicate whether at least some of the TXOP slots are shared slots to be shared among respective ones of a plurality of devices including the device, or dedicated slots dedicated to communication with respective ones of a plurality of devices including the device.

11. The device of claim 1, the TSF IE further being on a narrowband control channel, the device further including a radio integrated circuit to receive the TSF IE over a narrowband control channel, and to switch to one or more narrowband service channels to transmit the data frame.

12. The device of claim 11, further comprising one or more antennas coupled to the radio integrated circuit.

13. A product comprising one or more tangible computer-readable non-transitory storage media comprising computer-executable instructions operable to, when executed by at least one computer processor, cause the at least one computer processor to implement operations at a wireless communication device, the operations comprising:
processing a time synchronization function (TSF) information element (IE) from an access point (AP), the TSF IE including information on a plurality of transmit opportunity (TXOP) slots in a frequency domain and in a time domain, the TXOP slots indicating respective narrowband channels of a wideband channel in the frequency domain for communication with the device;
generating a data frame based on the TSF;
causing transmission of the data frame over a subset of the TXOP slots, the subset being aggregated over at least one of the frequency domain and the time domain.

14. The product of claim 13, wherein the TSF IE includes an indication that at least some of the TXOP slots are shared slots to be shared among respective ones of a plurality of devices including the device, and wherein the operations further include performing clear channel assessment (CCA) and invoke a backoff procedure on the shared slots to gain access to the subset of TXOP slots.

15. The product of claim 13, wherein the TSF IE includes an indication that at least some of the TXOP slots are dedicated slots dedicated to communication with respective ones of a plurality of devices including the device, and wherein the subset of the TXOP slots is included within the dedicated slots for the device.

16. The product of claim 13, wherein the subset of TXOP slots includes TXOP slots that are adjacent to one another in at least one of the frequency domain and the time domain.

17. The product of claim 13, wherein the operations further include causing transmission of the data frame over the subset of the TXOP slots based on at least one of quality of service (QoS) requirements for the data frame, power requirements for the data frame, and traffic load on the narrowband channels.

18. The product of claim 13, wherein the TSF includes a plurality of TSF schedule elements, the TSF schedule elements including the information on the plurality of transmit opportunity (TXOP) slots.

19. The product of claim 18, wherein each TSF schedule element includes a starting time slot number and narrowband channel bitmap to indicate the subset of TXOP slots.

20. The product of claim 18, wherein each TSF schedule element further includes a Maximum TXOP Duration field, the Maximum TXOP Duration field indicating the maximum packet exchange duration allowed in the time domain for the aggregated subset of TXOP slots.

21. The product of claim 18, wherein each TSF schedule element includes a TXOP bit field to indicate whether at least some of the TXOP slots are shared slots to be shared among respective ones of a plurality of devices including the device, or dedicated slots dedicated to communication with respective ones of a plurality of devices including the device.

22. A wireless communication device including:
means for processing a time synchronization function (TSF) information element (IE) from an access point (AP), the TSF IE including information on a plurality of transmit opportunity (TXOP) slots in a frequency domain and in a time domain, the TXOP slots indicating respective narrowband channels of a wideband channel in the frequency domain for communication with the device;
means for generating a data frame based on the TSF;
means for causing transmission of the data frame over a subset of the TXOP slots, the subset being aggregated over at least one of the frequency domain and the time domain.

23. The device of claim 22, wherein the TSF IE includes an indication that at least some of the TXOP slots are shared slots to be shared among respective ones of a plurality of devices including the device, and wherein the device further includes means for performing clear channel assessment (CCA) and invoking a backoff procedure on the shared slots to gain access to the subset of TXOP slots.

24. The device of claim 22, wherein the TSF includes a plurality of TSF schedule elements, the TSF schedule elements including the information on the plurality of transmit opportunity (TXOP) slots, and wherein the TSF IE further includes a starting time slot number and narrowband channel bitmap to indicate the subset of TXOP slots.

25. The device of claim 24, wherein each TSF schedule element further includes a Maximum TXOP Duration field, the Maximum TXOP Duration field indicating the maximum packet exchange duration allowed in the time domain for the aggregated subset of TXOP slots.
